(19) United States
(12) Patent Application Publication
(10) Pub. No.: US 2009/0216160 A1
(43) Pub. Date: Aug. 27, 2009

(54) Focusing System for a Device for Producing Shock Waves

(75) Inventor: Werner Schwarze, Jena (DE)

Correspondence Address: KING & SPALDING, 1180 PEACHTREE STREET , NE, ATLANTA, GA, 30309-3521, US

(73) Assignee: AST GMBH, Jena (DE)

(21) Appl. No.: 11/918,532

(22) PCT Filed: Apr. 11, 2006
(86) PCT No.: PCT/EP2006/003327

§ 371 Date: Jan. 23, 2009

(30) Foreign Application Priority Data
Apr. 15, 2005 (DE) 10 2005 017 724

(51) Int. Cl. A61H 1/00

(52) U.S. Cl. 601/4

(57) ABSTRACT

A system for directing shock waves splits the shock waves into a plurality of components that are reflected or combined in multiple focal points arranged along a common focal line. The system comprises a rotationally symmetrical body, and the common focal line corresponds with a line of symmetry of the body.

### RELATED PATENT APPLICATIONS

This patent application claims priority to and is a national stage application of PCT Patent Application No. PCT/EP2006/003327, filed Apr. 11, 2006 and titled “Focusing System for a Device for Producing Shockwaves,” which claims priority to German Patent Application No. DE 44 21 938 C2, filed Apr. 15, 2005 and titled “Focusing System for a Device for Producing Shockwaves.” The disclosure of each of the above-identified patent applications is hereby fully-incorporated herein by reference.

### TECHNICAL FIELD

The invention relates generally to a focusing system for a device for generating shock waves that is connected to the output of the shock waves and more particularly to directing the shock waves.

### BACKGROUND

Devices for generating focused acoustic waves generally involve reflecting the shock waves between two reflection planes that are aligned in relation to one another in such a way that all reflected portions of the shock wave are combined at a common focal point. The focal point is the treatment plane of the human or animal body.

Devices of this kind can be used, for example, for lithotripsy of kidney stones and have been a component of medical technology for several decades. However, conventional devices for generating shock waves suffer from certain disadvantages. For example, the kidney stone that is the target of the lithotripsy has to be positioned exactly at the focus of the shock wave to both shatter the kidney stone with sufficient energy and to exclude the possibility of destruction of adjacent human tissue by incorrect positioning of the focal point. The treatment often takes a long time, and the patient receiving therapy must remain as immobilized as possible in the targeted focal point. Any movement by the patient therefore requires realignment of the focal point of the device for generating shock waves with the treatment focus inside the patient.

### SUMMARY

The invention provides a focusing system for a device for generating shock waves of the aforementioned kind such that individually created shock waves are split into multiple shock wave components without the individual components of the reflected or combined shock wave being brought together in a single focal point. Instead, the components of the reflected or combined shock waves pass through the patient in such a way that the reflected shock wave is combined into a line of focal points in an axial emission direction.

In one aspect of the invention, a reflector, a lens, or a shock wave generation system can possess a curvature in accordance with the length of the focal line and the therapy. Further, the device for generating the shock wave can be arranged so it can move in relation to the focusing direction.

The invention allows for the precise calculation of the arrangement of the individual reflection mirrors and for accurate positioning of the focal lens segments. Therefore, each primary shock wave is split into specific reflected components, each of which takes a different path, with the effect that the components of a shock wave pass through a plurality of focal points outside the focal direction. These individual focal points form a focal line that runs in line with the axis of symmetry of a rotationally symmetrical body. The treatment focus of the patient is positioned within the focal line.

One advantage of positioning the patient on a focal line of this type is that the therapist can apply treatment largely independently of the depth information relating to the treatment location. Furthermore, certain geometries of the reflector or the lens segments give rise to both tensile and pressure wave components along the focal line, which can be used in a targeted manner for lithotripsy of kidney stones and for healing or stimulating bone tissue, insertion tendonitis, wound healing, or other therapies. The superimposed or time-sequential pressure and tensile or tensile and pressure wave components lead to more rapid therapeutic successes in the medical therapy of a patient and make it possible to reduce the shock wave energy required, thereby reducing the treatment time while the neighboring tissue is not affected or not impaired to any significant extent.

Furthermore, the patient does not have to be arranged precisely in a focal point or fixed in one position for the duration of treatment. Rather, the treatment focus is significantly loaded in the area of the focal line with the effect that the kidney stone, for example, is shattered simultaneously with its concretions. This process means the treatment focus can be arranged in the area of maximum convergence without the need for the patient to be moved and repositioned

### BRIEF DESCRIPTION OF THE DRAWINGS

FIG. 1 illustrates a focusing system for reflecting shock waves that are generated by a device, in which the axially proximate primary shock waves are focused in the distal area of the focal line and the axially remote shock waves are focused in the proximal area of the focal line, according to an exemplary embodiment.

FIG. 2 illustrates a focusing system for reflecting shock waves that are generated by a device, in which the axially proximate primary shock waves are focused in the proximal area of the focal line and the axially remote shock waves are focused in the distal area of the focal line, according to another exemplary embodiment.

FIGS. 3a and 3b illustrate a focusing system combining shock waves by means of lens segments, in which the shock waves are generated by a device, according to exemplary embodiment.

FIG. 4 illustrates a focusing system for reflecting shock waves generated by a piezoelectric device, according to an exemplary embodiment.

FIG. 5 illustrates a focusing system for combining shock waves using a reflector, in which the shock waves are generated by a cylindrical device, according to an exemplary embodiment.

FIG. 6 illustrates a sectional view of a device for generating shock waves that is arranged movably and can be positioned freely within a focusing system, according to an exemplary embodiment.

FIG. 7 illustrates the device and the focusing system in accordance with FIG. 6, with an adjustment spindle for moving and positioning the device, according to an exemplary embodiment.

### DETAILED DESCRIPTION OF EXEMPLARY EMBODIMENTS

Referring to the drawings, in which like numerals represent like elements, aspects of the exemplary embodiments will be described.

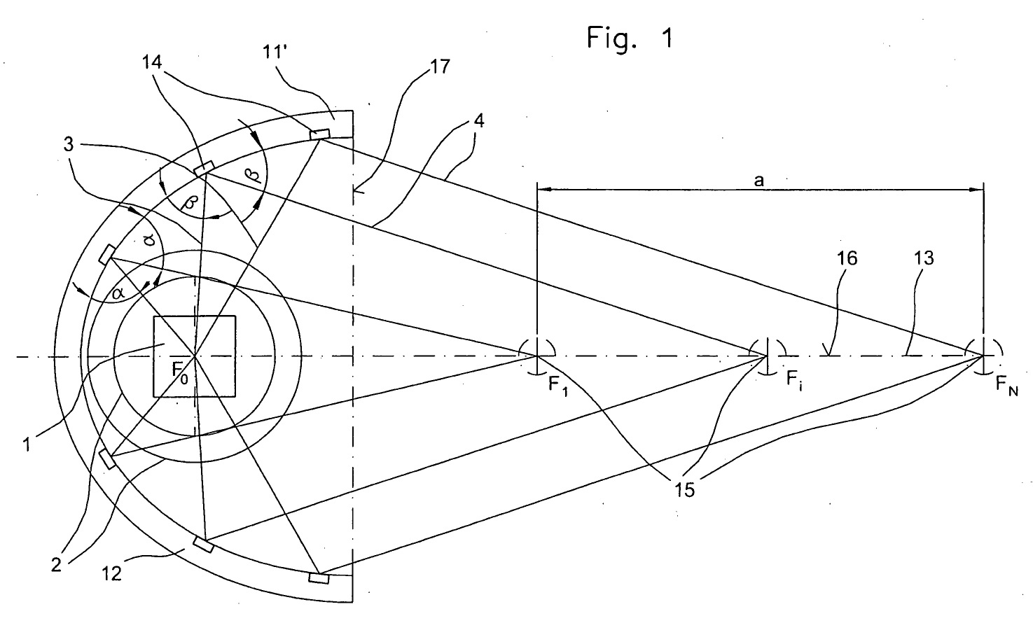

FIG. 1 shows a device 1 for generating shock waves 2 that is arranged within a focusing system 11′ in such a way that the emitted shock waves 2 are reflected by the focusing system 11′. In this case, a certain shock wave component 3 of the generated shock wave 2 is assigned to each area of the focusing system 11′.

The focusing system 11′ is configured as a rotationally symmetrical body 12. The device 1 is arranged on the axis of symmetry 13 of the rotationally symmetrical body 12 so that the source of the device 1 for generating shock waves 2 lies exactly on the axis of symmetry 13.

The inner surface of the rotationally symmetrical body 12 has a plurality of reflection mirrors 14 that are shown schematically. Therefore, a certain shock wave component 3 of the shock wave 2 is assigned to each reflection mirror 14, so that, because of the prevailing geometrical alignment of the reflection mirror 14, the shock wave component 3 of the shock wave 2 is reflected according to the physical law of the angle of incidence (a, B)=angle of reflection (a, B). The shock wave 2 is therefore split into primary shock wave components 3, before they strike the surface of the focusing system 11′, and secondary components 4 that are reflected by the reflection mirrors 14 of the focusing system 11′. The rotationally symmetrical body 12 has an output plane 17 through which all the reflected secondary components 4 of the shock waves 2 pass.

Outside the focusing system 11′, on the right next to the output plane 17, the reflected secondary components 4 of the shock wave 2 pass through a plurality of focal points 15 because each secondary component 4 of the shock wave 2 is combined in a different focal point 15 lying on the axis of symmetry 13. Each of the focal points therefore forms a common focal line 16 that runs in line with the axis of symmetry 13. The focal line 16 is therefore created outside the focusing system 11′ and has a length a of approx. 0 to 25 cm.

Pressure and tensile wave components of the reflected secondary components 4 of the shock wave are superimposed on the focal line 16. In the shock wave arrangements described herein with reference to FIGS. 1-5, the pressure wave components of the shock wave 2 are transformed into tensile wave components after passing through the focal line 16 on the axis of symmetry 13. These tensile wave components are superimposed with subsequent pressure waves that arrive on the focal line 16 from adjacent spatial segments of the shock wave 2 at a later time. In an exemplary embodiment, a pressure distribution along the focal line can be at least 100 bar.

Various focal lines and lengths are recommended for different shock wave therapies according to the anatomical conditions, with measurements taken starting from the output plane 17:
For urolitholysis, focal lines from 20 to 180 mm
For treating bone tissue, focal lines from 0 to 150 mm
For treating insertion tendonitis, focal lines from 0 to 100 mm
For trigger point acupuncture, focal lines from 0 to 120 mm
For wound and tissue healing, also focal lines from 0 to 120 mm

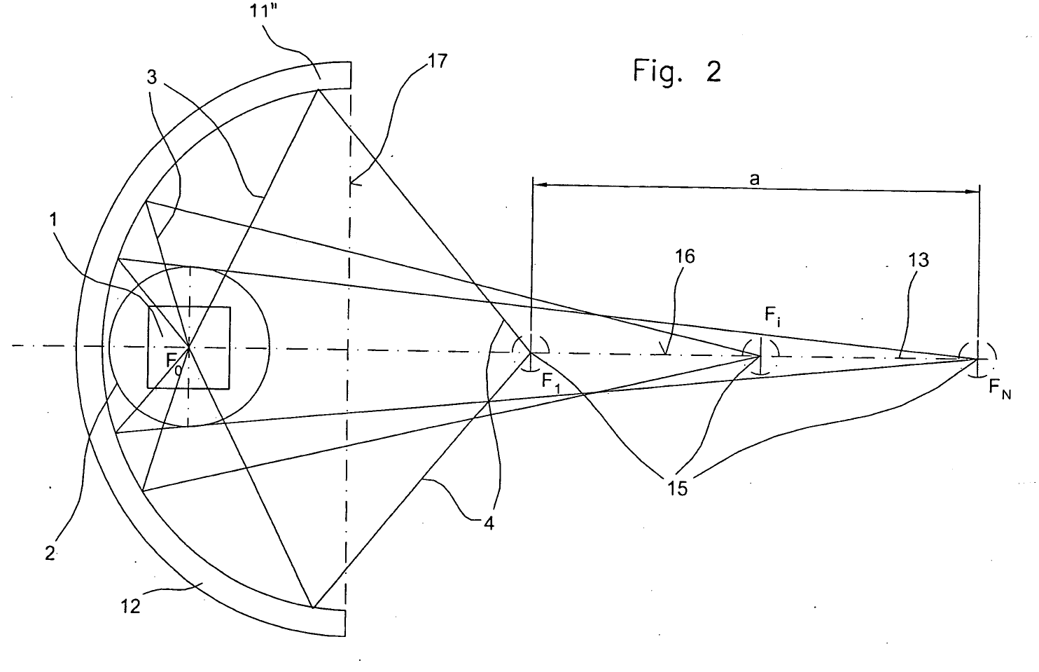

FIG. 2 shows the secondary components 4 of the shock wave 2 reflected at the surface of the rotationally symmetrical body 12 of a focusing system 11″ in such a way that the secondary components 4 of the shock wave 2 close to the axis of symmetry 13 are focused in the distal area F_{N} of the focal line 16 and the components of the shock wave 2 remote from the axis of symmetry are focused in the proximal area F₁ of the focal line 16. The corresponding reflection behavior of the reflector 12 in FIGS. 1 and 2 is achieved by the special arrangement and/or curvature of the reflection mirrors 14 or the surface shape of the body 12.

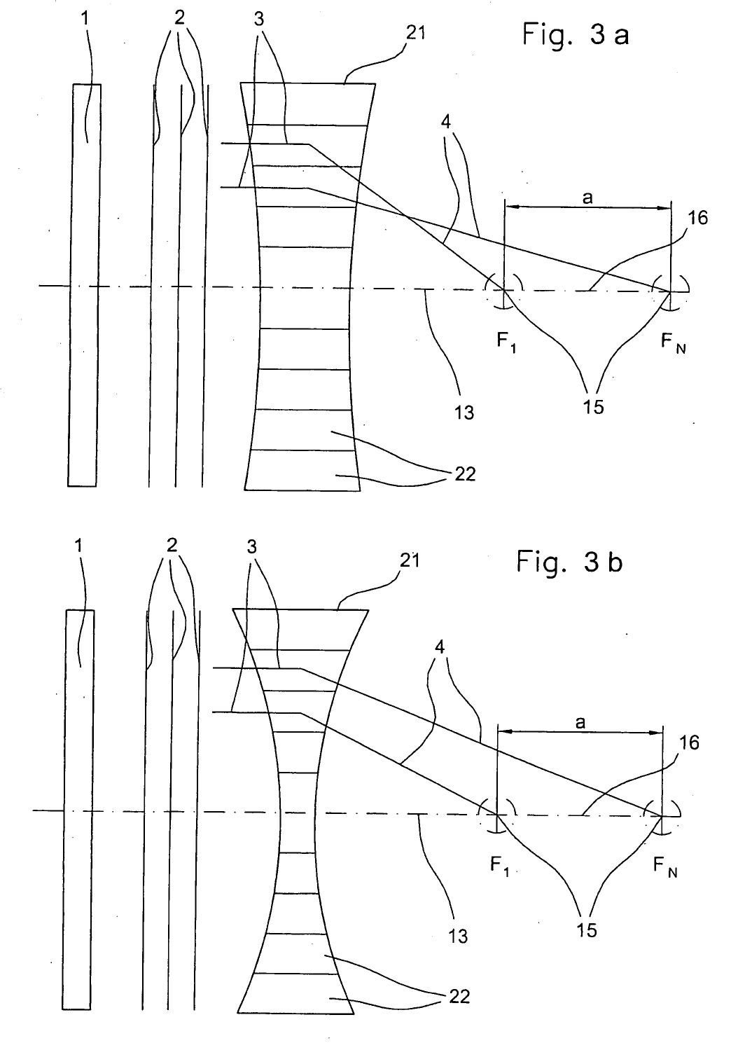

FIGS. 3a and 3b show that the individual primary shock wave components 3 or the shock wave 2 are combined by a focal lens 21 with a plurality of lens segments 22, with the effect that the primary shock wave components 3 of the shock wave 2 are deflected into a plurality of focal points 15. The lens segments 22 can be set and have different focusing properties for the shock wave 2.

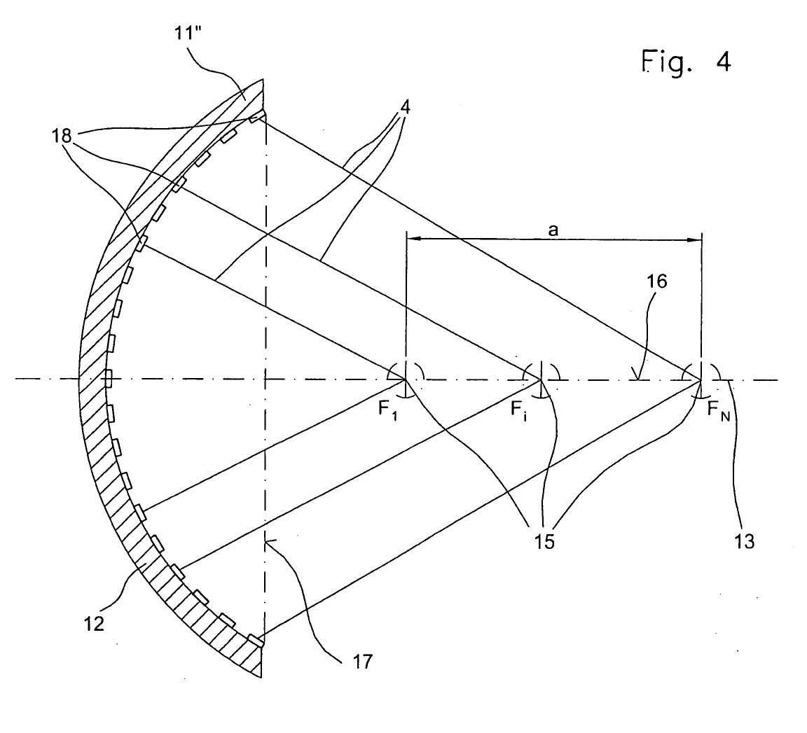

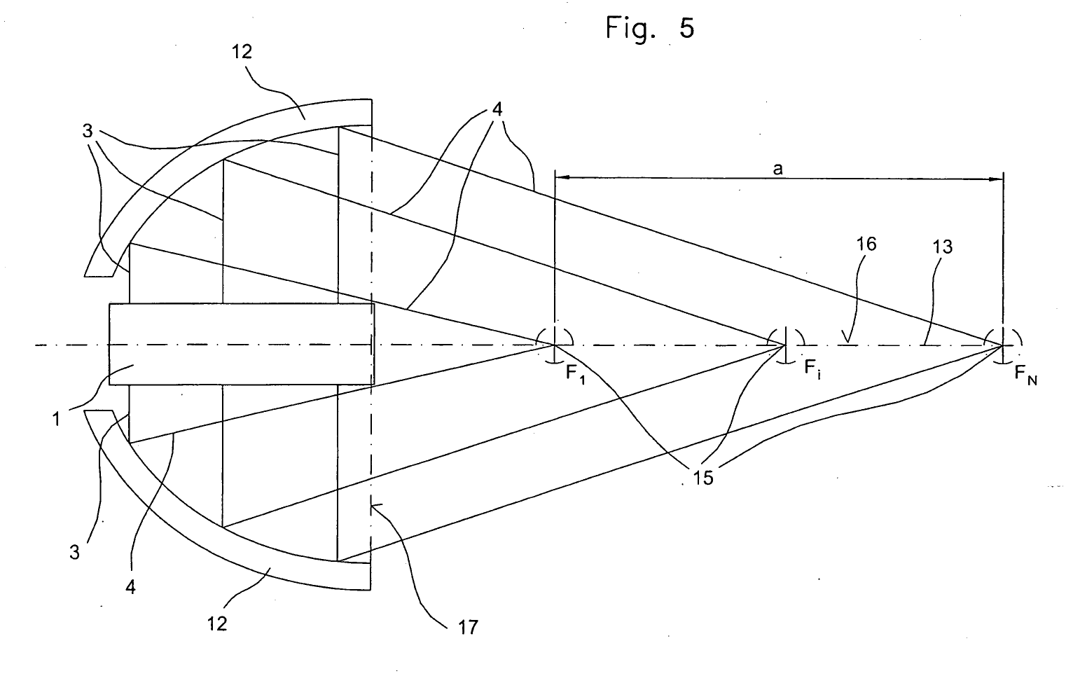

All known generating devices can be used as the device 1 for generating shock waves 2, in addition to the examples in FIGS. 1-3. For example, electromagnetic shock wave generators or piezoelectric shock wave generators are suitable as the device 1. The corresponding reflectors or surfaces can be configured according to the device 1. Such configuring is shown in FIGS. 4 and 5.

FIG. 4 illustrates a focusing system for reflecting shock waves generated by a piezoelectric device, according to an exemplary embodiment. As illustrated in FIG. 4, piezoelectric elements 18 are disposed along the body 12 and are configured as appropriate to focus the components 4 along the focal line 16.

FIG. 5 illustrates a focusing system for combining shock waves using a reflector, in which the shock waves are generated by a cylindrical device, according to an exemplary embodiment.

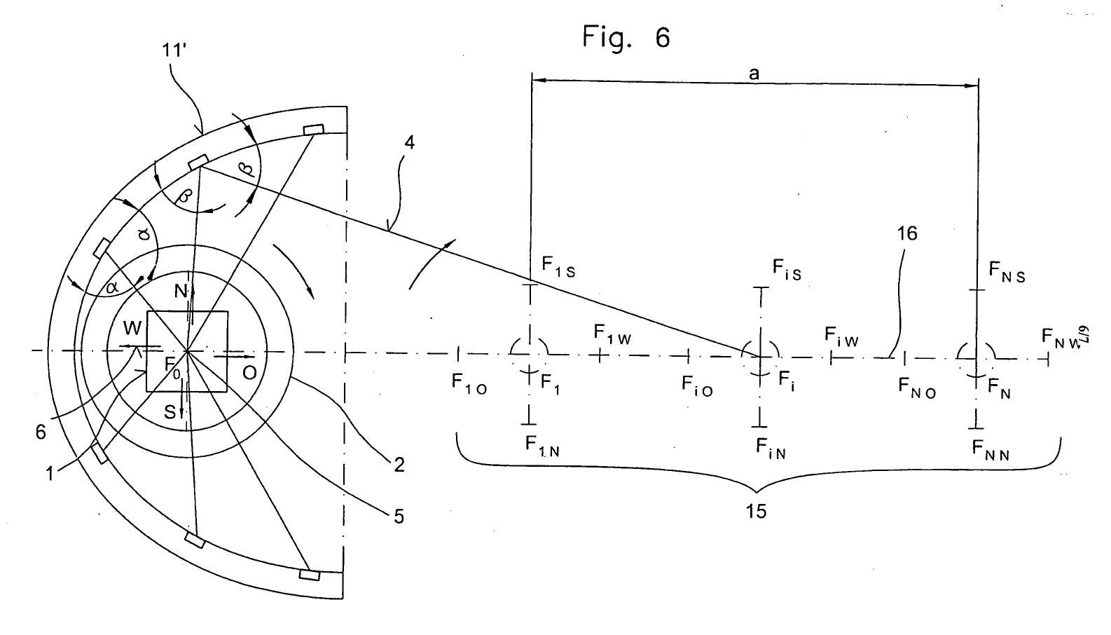

In FIG. 6, the device 1 for generating shock waves 2 is arranged within the focusing system 11′ as a parabolic mirror. The device 1 can be moved out of the focal point 5, and in all directions. A standard compass display 6 is drawn in the center of the device 1 to represent the movement of the device 1 relative to the focusing system 11′. The movement direction upwards corresponds to the orientation to the north (N) in this case. This orientation is continued accordingly. The individual focal points 15 run axially along the focal line 16 and can also be arranged laterally to the focal line 16 according to the movement of device 1. This kind of lateral configuration of secondary components 4 and/or primary shock wave components 3 of the shock wave 2 generated by the device 1 is created when the device 1 is moved to the north (N) and/or to the south (S) according to the drawing of the compass 6.

Accordingly, the configuration of the primary and secondary shock wave components 3 and 4 does not change because the performance parameters of the device 1 are kept constant. However, the movement of the device 1 relative to the focusing system 11′ allows a larger spatial treatment center to be covered because the focal line 16 can be extended by moving the device 1, for example, in an axial direction corresponding to a movement of the device 1 to the west (W) or east (O), causing the primary and secondary shock wave components 3 and 4 to stretch, and moving the device 1 to the north (N) or south (S) moves the focal line 16 in a lateral direction. A lateral arrangement of the shock wave components 3 and 4 of this kind can be seen by the designations F_{1S}, F_{iS}, and F_{NS}. In this case, the number 1 indicates it is the first focal point on the focal line 16, the letter i indicates the middle focal point, and the letter N indicates the last focal point of focal line 16. The other letters N, O, S, W indicate the focal point created by the corresponding movement of the device 1, for example, north.

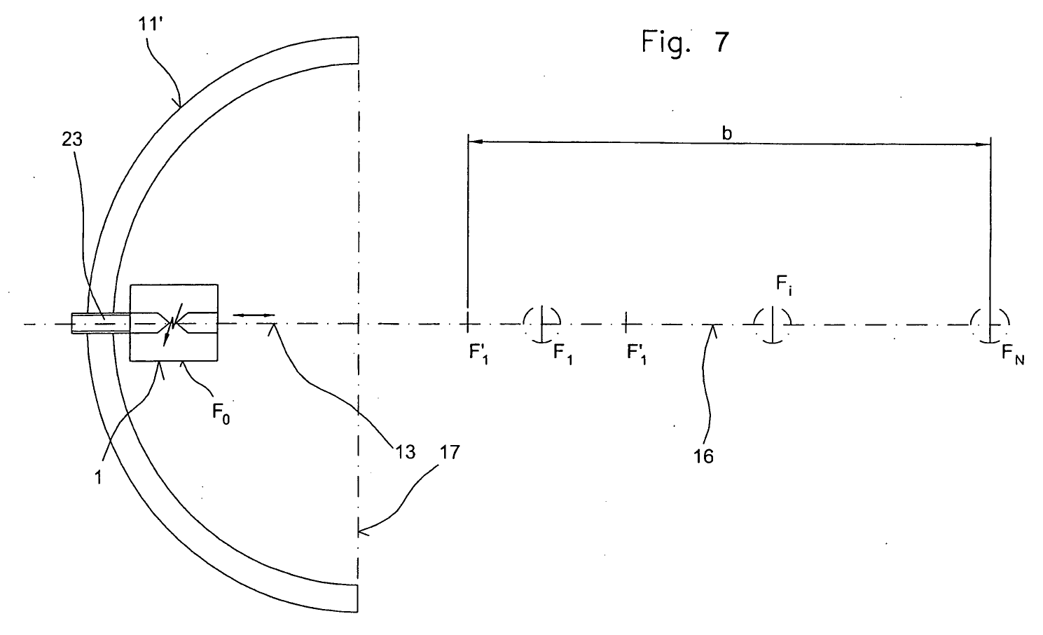

FIG. 7 shows that the device 1 is held supported in a thread 23 in the focusing system 11′. An adjusting spindle 24 attached to the device 1 acts as an adjusting element for positioning, moving, and/or fixing the device 1. The device 1 can therefore be moved along the axis of symmetry 13 of the focusing system 11′ from the outside. This means the focal line 16 extends and creates a maximum distance b that is larger than the distance a in FIG. 1 between the first and last focal points 15.

1-15. (canceled)

16. A system for directing shock waves, comprising:
a body comprising a directing device and being rotationally symmetric about an axis of symmetry, the directing device receiving components of a shock wave and directing the components into a plurality of focal points arranged on a focal line.

17. The system of claim 16, further comprising a device that generates the shock wave, the device being disposed within the body and being movable with respect to the body.

18. The system of claim 17, wherein the device is movable in an axial direction and a lateral direction with respect to the body, thereby increasing an area in which the focal points are arranged while maintaining performance parameters of the device.

19. The system of claim 16, wherein the body defines an output plane, and wherein the focal line is disposed outside the body beyond the output plane.

20. The system of claim 16, wherein the body has a shape that comprises a half cylinder or a spherical cup.

21. The system of claim 16, wherein the directing device is movable into a plurality of alignments with respect to the components of the shock wave.

22. The system of claim 16, wherein the directing device comprises a surface of the body, a plurality of reflection mirrors coupled to the body, or a plurality of lens segments within a focal lens.

23. The system of claim 16, wherein the directing device comprises a plurality of reflection mirrors disposed continuously and adjacent to each other on a surface of the body.

24. The system of claim 16, wherein the directing device comprises a plurality of lens segments disposed continuously and adjacent to each other within a focal lens.

25. The system of claim 16, wherein the directing device comprises a plurality of lens segments arranged substantially perpendicular to a path of the components of the shock wave.

26. The system of claim 16, wherein a length of the focal line is based on at least one of a shape of the body, an alignment of the directing device, and an intensity of the shock wave.

27. The system of claim 26, wherein the length of the focal line is in a range from 0 cm to 25 cm.

28. The system of claim 16, wherein the focal line is on the axis of symmetry of the body.

29. The system of claim 16, wherein pressure and tensile wave components of the shock wave are superimposed over one another along the focal line.

30 The system of claim 16, wherein a pressure and an energy of each of the directed components of the shock wave are constant in the focal line.

31. The system of claim 16, wherein a pressure distribution along the focal lint is at least 100 bar.

32. A system for directing shock waves, comprising:
a device that generates a shock wave, the shock wave comprising a plurality of components;
a directing body comprising a directing device and being rotationally symmetric about an axis of symmetry, the directing device directing the components of the shock wave into a plurality of focal points arranged on a focal line,
wherein the device is disposed within the directing body and is movable with respect to the directing body.

33. The system of claim 32, wherein the device is movable in an axial direction and a lateral direction with respect to the body, and wherein movement of the device in the axial direction with respect to the body moves the focal points on the focal line and movement of the device in the lateral direction moves the focal points with respect to the axis of symmetry.

34. The system of claim 32, wherein the directing body defines an output plane, and wherein the focal line is disposed outside the directing body beyond the output plane.

35. The system of claim 32, wherein the directing device comprises a surface of the body, a plurality of reflection mirrors coupled to the body, or a plurality of lens segments disposed within a focal lens.

36. The system of claim 32, wherein the directing device comprises a plurality of reflection mirrors coupled to the body or a plurality of lens segments, and
wherein the directing device is movable into a plurality of alignments with respect to the components of the shock wave.

37. The system of claim 32, wherein the directing device comprises a plurality of reflection devices disposed continuously and adjacent to each other on a surface of the body.

38. The system of claim 32, wherein the focal line is on the axis of symmetry of the body.

39. The system of claim 32, wherein pressure and tensile wave components of the shock wave are superimposed over one another along the focal line.

40. The system of claim 32, wherein a pressure and an energy of each of the reflected components of the shock wave are constant in the focal line.
